(19) United States
(12) Patent Application Publication
(10) Pub. No.: US 2005/0077386 A1
(43) Pub. Date: Apr. 14, 2005

(54) Foamer

(76) Inventor: Michael T. Clarke, Alto, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/686,448

(22) Filed: Oct. 14, 2003

(51) Int. Cl. B05B 9/03

(52) U.S. Cl. 239/302; 239/317

(57) ABSTRACT

A sprayer comprising a sprayer container, a spraying gun, at least one fluid connection line and a fitting. The sprayer container is adapted to be filled with a liquid and a gas. The spraying gun is connected to the sprayer container, with the spraying gun including a trigger for selectively spraying a pressurized combination of liquid and gas onto a predetermined object. The at least one fluid connection line connects the spraying gun to the sprayer container, with the at least one fluid connection line configured to supply liquid and gas in the sprayer container to the spraying gun. The fitting connects the at least one fluid connection line to the sprayer container.

### BACKGROUND OF THE INVENTION

The present invention relates to sprayers, and in particular to portable sprayers for spraying foams.

Portable sprayers have been used to spray stains, sealants or protective coatings on decks, fences, brick walls, concrete walks, or other wood and masonry objects. Portable sprayers have also been used to spray acids, chemicals, pesticides, herbicides, degreasers, disinfectants, water proofing, carpet treatments, cleaners, sealers, curing compounds, form release agents, germicides, herbicides, insect control fluids, or any other fluid one would desire to spray onto an object. Portable sprayers have also been used to spray carpet cleaning solutions onto carpets for cleaning the carpets, foaming pesticides or herbicides onto various objects and other foaming solutions onto various objects.

Heretofore, portable foaming sprayers have included a tank or container for holding the fluids, a pump in the container for pressurizing the gas and liquid in the container and a spraying gun for spraying the combined gas and liquid onto a predetermined object. Two lines connected the spraying gun to the spraying container. The first line included a tube near a bottom of the spraying container for supplying pressurized fluid in the container to the spraying gun. The second line was connected to a top of the spraying container at a position spaced from the connection point of the first line to the sprayer container. The second line supplied pressurized gas to the spraying gun. The second line included a needle valve for controlling the flow of the gas to the spraying gun for altering the thickness of the foam produced in the spraying gun. Furthermore, the second line included a check valve to eliminate the possibility of the pressurized fluid from entering into the pressurized air line from the spraying gun.

Accordingly, an improved system having the aforementioned advantages is desired.

### SUMMARY OF THE INVENTION

One aspect of the present invention is to provide a sprayer comprising a sprayer container, a spraying gun, at least one fluid connection line and a fitting. The sprayer container is adapted to be filled with a liquid and a gas. The spraying gun is connected to the sprayer container, with the spraying gun including a trigger for selectively spraying a pressurized combination of liquid and gas onto a predetermined object. The at least one fluid connection line connects the spraying gun to the sprayer container, with the at least one fluid connection line being configured to supply liquid and gas in the sprayer container to the spraying gun. The fitting connects the at least one fluid connection line to the sprayer container.

Another aspect of the present invention is to provide a sprayer comprising a sprayer container, a spraying gun, at least one fluid connection line and a fitting. The sprayer container is adapted to be filled with a liquid and a gas. The spraying gun is connected to the sprayer container. The at least one fluid connection line connects the spraying gun to the sprayer container, with the at least one fluid connection line being configured to supply liquid and gas from the sprayer container to the spraying gun. The fitting connects the at least one fluid connection line to the sprayer container. The fitting has a one-way valve for preventing the gas in the at least one fluid connection line from returning to the sprayer container. The fitting further has a manually operated escape valve for allowing release of pressure in at least a portion of the at least one fluid connection line. The fitting also has a flow valve for selectively varying the amount of gas flow into the at least one fluid connection line.

These and other features, advantages, and objects of the present invention will be further understood and appreciated by those skilled in the art by reference to the following specification, claims and appended drawings.

### BRIEF DESCRIPTION OF THE DRAWINGS

FIG. 1 is a front view of a sprayer embodying the present invention, with a front of a sprayer container, a fitting and a fluid connection line cut away to illustrate details of the present invention.

FIG. 2 is a cross-sectional partial view of the sprayer of the present invention illustrating the fitting with a flow valve in a closed position.

FIG. 3 is a cross-sectional partial view of the sprayer of the present invention illustrating the fitting with the flow valve in an open position.

FIG. 4 is a cross-sectional partial view of the sprayer of the present invention illustrating the fitting with a flow valve in a release position.

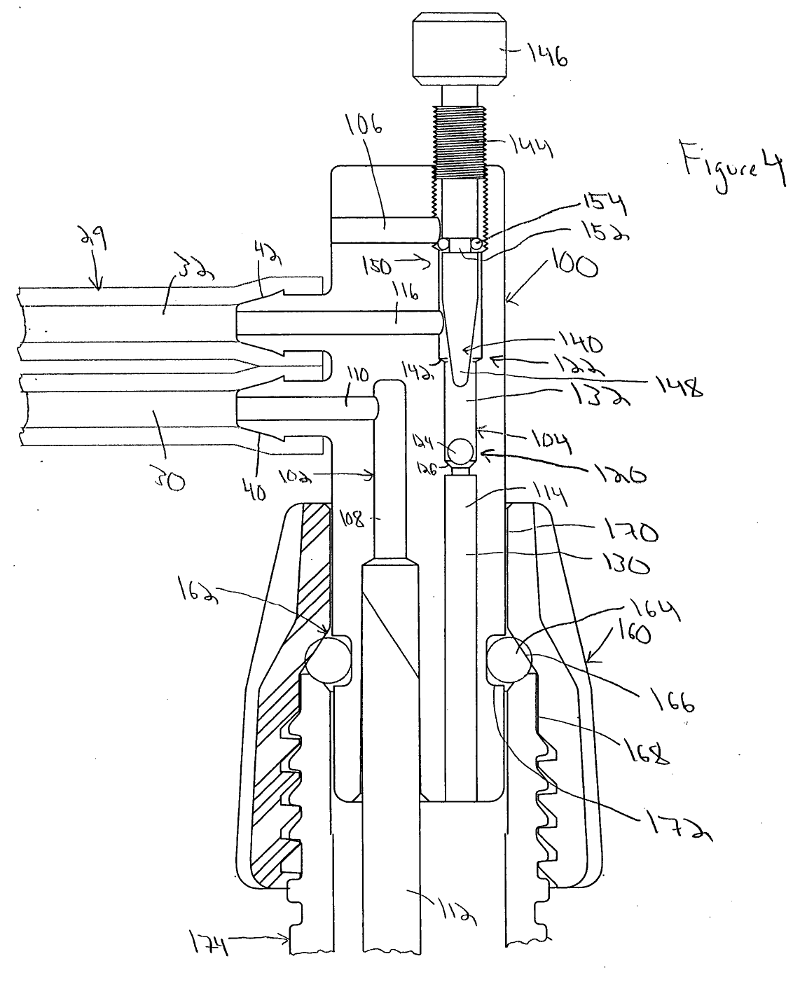

### DETAILED DESCRIPTION OF THE PREFERRED EMBODIMENTS

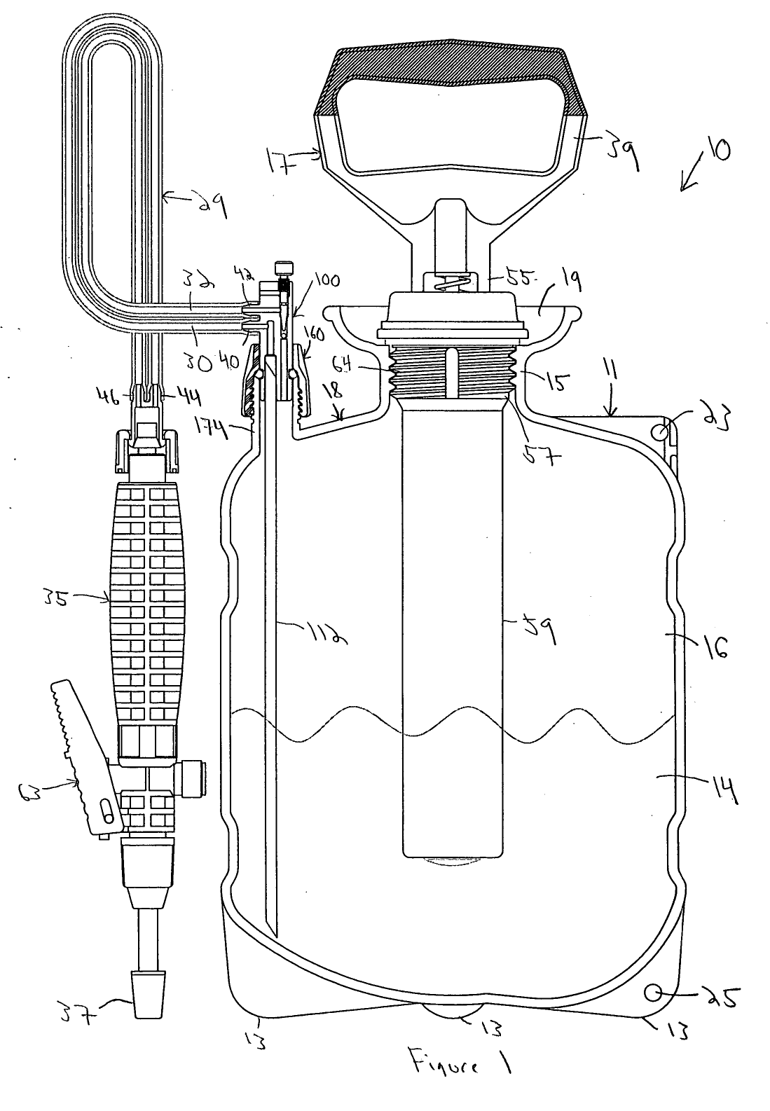

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIG. 1) generally designates a sprayer embodying the present invention. In the illustrated example, the sprayer 10 includes a sprayer container 11, a spraying gun 35, at least one fluid connection line 29 and a fitting 100. The sprayer container 11 is adapted to be filled with a liquid 14 and a gas 16. The spraying gun 35 is connected to the sprayer container 11, with the spraying gun 35 including a trigger 63 for selectively spraying a pressurized combination of liquid 14 and gas 16 onto a predetermined object. The at least one fluid connection line 29 connects the spraying gun 35 to the sprayer container 11, with the at least one fluid connection line 29 being configured to supply liquid 14 and gas 16 in the sprayer container 11 to the spraying gun 35. The fitting 100 connects the at least one fluid connection line 29 to the sprayer container 11.

The illustrated sprayer 10 is preferably used to spray a combination of the gas 16 and the liquid 14 located within the sprayer container 11 onto a predetermined object for covering the object with a foamy combination of the liquid and the gas. A hand pump 17 connects to the sprayer container 11 and is actuated to pressurize the fluid in the sprayer container 11. In use, the gas 16 and the liquid 14 in the spraying container 11 are pressurized with the hand pump 17 and the trigger 63 on the spraying gun 35 is depressed to eject the foamy combination of the gas and the liquid out of a nozzle 37 of the spraying gun 35. Preferably, the sprayer container 11 holds carpet cleaning solutions for spraying onto carpets for cleaning the carpets or foaming pesticides or herbicides for spraying onto plants and other objects.

In the illustrated example, the sprayer container 11 can be made from many different types of polymeric materials such as polyethylene and polypropylene, or from metal, such as stainless steel. In the preferred embodiment, the sprayer container 11 is made from high density polyethylene. It is recommended that one tenth percent (0.1%) by weight of an ultraviolet inhibitor be incorporated in the plastic composition used to manufacture the sprayer container 11. The sprayer container 11 is of an elliptical configuration and is preferably made by the conventional blow molding technique. The sprayer container 11 is illustrated as including a rounded upper portion 18. In the illustrated example, the sprayer container 11 includes feet 13 upon which the sprayer container rests. Centrally located in the top portion of the sprayer container 11 is an internally threaded inlet 15 into which the hand pump 17 is threadedly positioned. A funnel 19, also made of high density polyethylene, surrounds the top of the inlet 15. The sprayer container 11 preferably includes a pair of eyelets 23 and 25 to which a suitable shoulder strap (not shown) can be attached to facilitate carrying the sprayer 10. The sprayer container 11 can be made in many different sizes to fit different applications. Since it is intended to be a portable sprayer 10, the upper capacity limit would appear to be determined by the overall weight of sprayer container 11 and liquid. For most applications, a smaller sprayer container 11 would be suitable; and the one gallon and one and one-half gallon sizes are preferred. The one and one-half gallon sprayer container is approximately 14½ inches high to the top of the funnel and approximately 7½ inches at its maximum diameter. The wall thickness of the sprayer container 11 can also be varied. The sprayer container 11 should be designed to safely contain sufficient pressure for the liquid to be properly dispensed from the spray nozzle 37 on the spraying gun 35. If the walls are too thick, the additional material merely adds to the weight of the sprayer container 11 while serving no other useful purpose. A sprayer container 11 with a wall thickness of approximately 0.125 inches is preferred for most applications. The sprayer container 11 could also include a pressure relief valve (not shown).

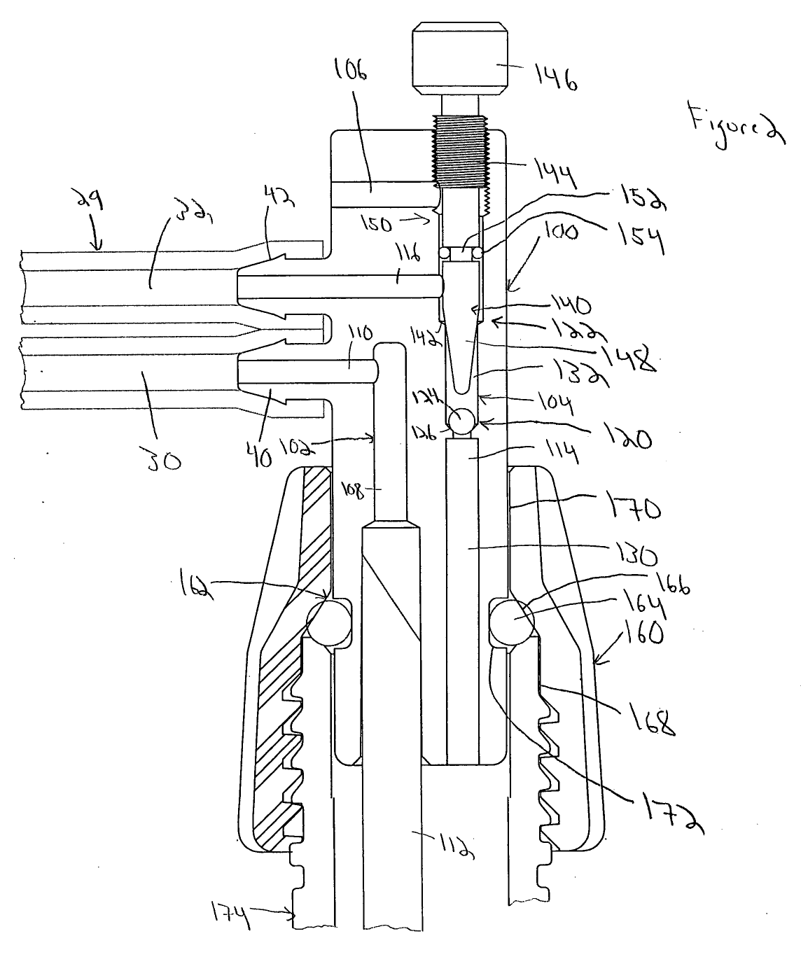

The illustrated hand pump 17 (FIG. 2) includes a handle 39, a plunger 55, a sleeve 57 and a cylinder 59. The plunger 55 extends into the cylinder 59 from the handle 39, and the handle 39 is actuated up and down to force air towards the bottom of the cylinder 59 with the plunger 55. The sleeve 57 includes an outside threaded surface 64 for engaging with the internally threaded inlet 15 of the sprayer container 11. The hand pump 17 is connected to the spraying container 11 by inserting the cylinder 59 into the funnel 19 of the spraying container 11 and screwing the outside threaded surface 64 into the internally threaded inlet 15. Once the sleeve 57 is screwed fully into the inlet 15, an air tight seal is created in the inlet 15 of the spraying container 11. The fluid in the spraying container 11 is pressurized by repetitively pressing down on the handle 39 of the hand pump 17 and forcing air into the spraying container 11. The spraying container 11 and the hand pump 17 described above are currently sold as Model 1001PGX Sprayer by RL Flo-Master of Lowell, Mich. In an alternative embodiment, the sprayer 10 can have the spraying container 11 being pressurized by a garden hose, as is currently sold as Model 2502TE Pro® NoPump® Sprayers by RL Flo-Master of Lowell, Mich.

In the illustrated example, the at least one fluid connection line 29 supplies the liquid 14 and the gas 16 from the sprayer container 11 to the spraying gun 35 through the fitting 100. The illustrated at least one fluid connection line 29 is illustrated comprising a single line having a figure eight configuration and including a first passage 30 for supplying the liquid 14 to the spraying gun 35 and a second passage 32 for supplying the gas 16 to the spraying gun 35. The fluid connection line 29 is connected to the fitting 100 by inserting a first end of the first passage 30 over a first pronged cylinder 40 of the fitting 100 and a first end of the second passage 32 over a second pronged cylinder 42 of the fitting 100. Likewise, the fluid connection line 29 is connected to the spraying gun 35 by inserting a second end of the first passage 30 over a first pronged cylinder 44 of the spraying gun 35 and a second end of the second passage 32 over a second pronged cylinder 46 of the spraying gun 35. Although the at least one fluid connection line 29 is illustrated as comprising one fluid connection line 29, it is contemplated that the at least one fluid connection line 29 could include two separate connection lines, with one of the two separate connection lines having the first passage 30 therein and the second of the two separate connection lines having the second passage 32 therein.

The illustrated fitting 100 supplies the pressurized liquid 14 and gas 16 from the sprayer container 11 to the spraying gun 35 via the at least one fluid connection line 29. The fitting 100 is illustrated as being connected to a top portion of the sprayer container 11. The fitting 100 includes a liquid passageway 102 and a gas passageway 104. The fluid passageway 102 includes a first portion 108 and a second portion 110. The first portion 108 opens into the interior of the sprayer container 11 and includes a supply tube 112 connected thereto and extending to a point adjacent a bottom of an interior of the sprayer container 11 for supplying the fluid 14 in the bottom of the interior of the sprayer container 11 to the at least one fluid connection line 29. The second portion 110 is connected to the first passage 30 of the at least one fluid connection line 29 by the first pronged cylinder 40. The gas passageway 104 includes a first portion 114 and a second portion 116. The first portion 114 opens into a top of the interior of the sprayer container 11. The second portion 116 is connected to the second passage 32 of the at least one fluid connection line 29 by the second pronged cylinder 42.

In the illustrated example, the fluid passageway 102 is always open and allows fluid flow in both directions in the fluid passageway 102. However, the gas passageway 104 can be selectively closed and only allows fluid flow in one direction.

The illustrated fitting 100 includes a one-way valve 120 for preventing the gas in the second passage 32 of the fluid connection line 29 from returning to the sprayer container 11. The one-way valve 120 includes a check ball 124 resting on a first seat 126 in the first portion 114 of the gas passageway 104. The first seat 126 divides the first portion 114 of the gas passageway 104 into a lower section 130 and an upper section 132. The lower section 130 is directly fluidly connected to the gas 16 in the interior of the sprayer container 11. In the illustrated example, the check ball 124 will lift off of the first seat 126 when the pressure of the gas in the lower section 130, and therefore in the interior of the sprayer container 11, is higher than the pressure of the gas in the upper section 132. The one-way valve 120 assists in preventing liquid from entering the second passage 32 of the fluid connection line 29 from the spraying gun 35. Although the one-way valve 120 is illustrated as comprising the check ball 124 on the first seat 126, it is contemplated that the one-way valve 120 could comprise any valve that would restrict flow of gas from the second passage 32 of the fluid connection line 29 into the interior of the sprayer container 11.

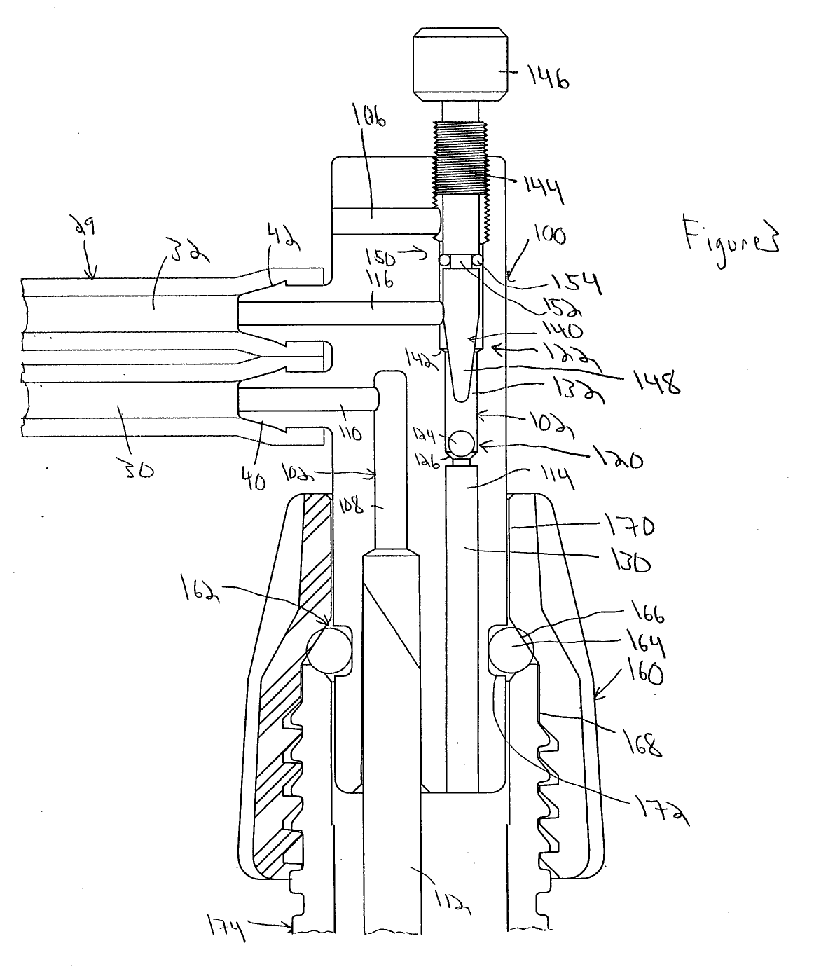

In the illustrated example, the fitting 100 also includes a flow valve 122 for selectively varying the amount of gas flow into the second passage 32 of the fluid connection line 29. The illustrated flow valve 122 comprises a needle valve 140 that engages a second seat 142 in the first portion 114 of the gas passageway 104. The needle valve 140 includes an outside threaded surface 144 that is screwed into an inside threaded surface of the first portion 114 of the gas passageway 104. As a knob 146 of the needle valve 140 is turned to move the needle valve 140 into the first portion 114 of the gas passageway 104, the needle 148 of the needle valve 140 will move towards the second seat 142 to restrict the flow of gas through the gas passageway 104 until the needle 148 abuts the second seat 142, thereby stopping the flow of gas through the gas passageway 104. Therefore, the flow valve 122 includes at least one open position (FIG. 3) and a closed position (FIG. 2). The amount of gas flowing through the gas passageway 104 controls the thickness of the foamy combination of the liquid and the gas in the spraying gun 35, with a higher gas flow resulting in a thicker foamy combination. Although the flow valve 122 is illustrated as comprising the needle valve 140, it is contemplated that the flow valve 122 could comprise any valve that would control the flow of gas through the gas passageway 104.

The illustrated fitting 100 further includes a manually operated escape valve 150 for allowing release of pressure in the second passage 32 of the fluid connection line 29. The fitting 100 includes an escape passageway 106 fluidly connected to upper section 132 of the first portion 114 of the gas passageway 104. The needle valve 140 includes an annular groove 152 having an O-ring 154 located therein. As illustrated in FIG. 5, when the needle valve 140 is turned to move the needle 148 away from the second seat 142, the O-ring 154 in the annular groove 152 of the needle valve 140 will pass the escape passageway 106, thereby allowing the gas in the gas passageway 104 and the second passage 32 to escape into the atmosphere. Although the manually operated escape valve 150 is illustrated as being manually operated and working with the needle valve 140, it is contemplated that the manually operated escape valve 150 could work automatically when the pressure in the gas passageway 104 and the second passage 32 rises above a predetermined level and the escape valve 150 could work independently of the needle valve 140.

In the illustrated example, the fitting 100 is connected to the sprayer container 11 without any tools using an inside threaded connector 160. The inside threaded connector 160 includes a stepped internal bore 162 and an O-ring 164 abutting a transition area 166 between a first area 168 of the inside threaded connector 160 and a second area 170 of the inside threaded connector 160. The O-ring 164 sits in an annular groove 172 in an outside surface of the fitting 100. The fitting 100 is connected to the sprayer container 11 by screwing the inside threaded connector 160 onto an outside threaded port cylinder 174 extending from a top of the sprayer container 11.

The illustrated sprayer 10 is preferably used by first unscrewing the hand pump 17 from the top of the sprayer container 11. A measured amount of the chemical used for spraying is then poured into the spraying container 11. Thereafter, the appropriate amount of water to dilute the mixture according to the chemical manufacturer's instructions is added to the sprayer container 11. The hand pump 17 is then screwed back into the top of the sprayer container 11. The handle 39 is then pumped up and down to pressurize the sprayer container 11. To spray the fluid in the sprayer container, the trigger 37 on the spraying gun 35 is depressed and pressure in the sprayer container 11 will force the diluted mixture up the supply tube 112, through the liquid passageway 102 of the fitting 100 and through the first passage 30 of the fluid connection line 29 and into the spraying gun 35 where the fluid will mix with the gas forced into the spraying gun 35 as the pressure in the sprayer container 11 forces the gas in the sprayer container 11 through the gas passageway 104 of the fitting and through the second passage 32 of the fluid connection line 29 and into the spraying gun 35. The spraying gun 35 will then mix the liquid and the gas in a manner well known to those skilled in the art to produce the foamy combination of the gas and the liquid. Finally, the foamy combination of the gas and the liquid will be ejected out of the nozzle 37 of the spraying gun 35.

In the forgoing description, it will be readily appreciated by those skilled in the art that modifications may be made to the invention without departing from the concepts disclosed herein. For example, although a specific sprayer container 11, pump 17 and gun 35 are disclosed herein, any configuration can be used for the container 11, pump 17 and/or gun 35. Such modifications are to be considered as included in the following claims, unless these claims by their language expressly state otherwise.

1. A sprayer comprising:
a sprayer container adapted to be filled with a liquid and a gas;
a spraying gun connected to the sprayer container, the spraying gun including a trigger for selectively spraying a pressurized combination of liquid and gas onto a predetermined object;
at least one fluid connection line connecting the spraying gun to the sprayer container, the at least one fluid connection line configured to supply liquid and gas in the sprayer container to the spraying gun; and
a fitting connecting the at least one fluid connection line to the sprayer container.

2. The sprayer of claim 1, wherein:
the at least one fluid connection line comprises a first passage for supplying the liquid to the spraying gun and a second passage for supplying the gas to the spraying gun.

3. The sprayer of claim 2, wherein:
the fitting includes a one-way valve for preventing the gas in the second passage from returning to the sprayer container.

4. The sprayer of claim 3, wherein:
the fitting includes a manually operated escape valve for allowing release of pressure in the second passage.

5. The sprayer of claim 4, wherein:
the fitting includes a flow valve for selectively varying an amount of gas flow into the second passage.

6. The sprayer of claim 5, wherein:
the flow valve is a needle valve.

7. The sprayer of claim 3, wherein:
the fitting includes a flow valve for selectively varying an amount of gas flow into the second passage.

8. The sprayer of claim 7, wherein:
the flow valve is a needle valve.

9. The sprayer of claim 2, wherein:
the fitting includes a manually operated escape valve for allowing release of pressure in the second passage.

10. The sprayer of claim 9, wherein:
the fitting includes a flow valve for selectively varying an amount of gas flow into the second passage.

11. The sprayer of claim 10, wherein:
the flow valve is a needle valve.

12. The sprayer of claim 2, wherein:
the fitting includes a flow valve for selectively varying an amount of gas flow into the second passage.

13. The sprayer of claim 12, wherein:
the flow valve is a needle valve.

14. The sprayer of claim 2, wherein:
the at least one fluid connection line comprises a tube having the first passage and the second passage therein.

15. The sprayer of claim 1, further including:
a hand pump for pressurizing the gas and the liquid in the sprayer container.

16. The sprayer of claim 1, further including:
a supply tube connected to the fitting and extending to a point adjacent a bottom of an interior of the sprayer container for supplying fluid in the bottom of the interior of the sprayer container to the at least one fluid connection line.

17. The sprayer of claim 1, further including:
an inside threaded connector;
wherein the sprayer container includes an outside threaded port cylinder and the inside threaded connector is screwed into the outside threaded port cylinder to connect the fitting to the sprayer container.

18. A sprayer comprising:
a sprayer container adapted to be filled with a liquid and a gas;
a spraying gun connected to the sprayer container;
at least one fluid connection line connecting the spraying gun to the sprayer container, the at least one fluid connection line configured to supply liquid and gas from the sprayer container to the spraying gun; and
a fitting connecting the at least one fluid connection line to the sprayer container, the fitting having a one-way valve for preventing the gas in the at least one fluid connection line from returning to the sprayer container, the fitting further having a manually operated escape valve for allowing release of pressure in at least a portion of the at least one fluid connection line, and the fitting also having a flow valve for selectively varying the amount of gas flow into the at least one fluid connection line.

19. The sprayer of claim 18, wherein:
the at least one fluid connection line comprises a first passage for supplying the liquid to the spraying gun and a second passage for supplying the gas to the spraying gun.

20. The sprayer of claim 19, wherein:
the one-way valve prevents the gas in the second passage from returning to the sprayer container.

21. The sprayer of claim 20, wherein:
the flow valve selectively varies the amount of gas flow into the second passage.

22. The sprayer of claim 21, wherein:
the flow valve is a needle valve.

23. The sprayer of claim 19, wherein:
the flow valve selectively varies the amount of gas flow into the second passage.

24. The sprayer of claim 23, wherein:
the flow valve is a needle valve.

25. The sprayer of claim 18, wherein:
the flow valve selectively varies the amount of gas flow into the second passage.

26. The sprayer of claim 25, wherein:
the flow valve is a needle valve.

27. The sprayer of claim 18, wherein:
the flow valve is a needle valve.

28. The sprayer of claim 18, wherein:
the at least one fluid connection line comprises a tube having the first passage and the second passage therein.

29. The sprayer of claim 18, further including:
a hand pump for pressurizing the gas and the liquid in the sprayer container.

30. The sprayer of claim 18, further including:
a supply tube connected to the fitting and extending to a point adjacent a bottom of an interior of the sprayer container for supplying liquid in the bottom of the interior of the sprayer container to the at least one fluid connection line.

31. The sprayer of claim 18, wherein:
the escape valve is manually operable.

32. The sprayer of claim 18, further including:
an inside threaded connector;
wherein the sprayer container includes an outside threaded port cylinder and the inside threaded connector is screwed into the outside threaded port cylinder to connect the fitting to the sprayer container.
